(19) United States
(12) Patent Application Publication
(10) Pub. No.: US 2019/0010954 A1
(43) Pub. Date: Jan. 10, 2019

(54) VANE WHEEL AND BLOWING DEVICE

(71) Applicant: Nidec Corporation, Kyoto (JP)

(72) Inventor: Masashi TAKAO, Kyoto (JP)

(21) Appl. No.: 15/985,744

(22) Filed: May 22, 2018

(30) Foreign Application Priority Data
Jul. 5, 2017 (JP) 2017-131827

(51) Int. Cl. F04D 29/26; F04D 29/24; F04D 29/62; F04D 17/08

(52) U.S. Cl. CPC F04D 29/263; F04D 29/242; F04D 29/626; F04D 17/08; F05D 2250/711; F05D 2240/30; F05D 2240/60; F05D 2250/131; F05D 2250/232; F05D 2240/14

(57) ABSTRACT

A vane wheel includes a shaft, an impeller, and a fixing member. The impeller includes an impeller cylinder portion into which one end portion of the shaft in an axial direction is inserted. The fixing member is disposed on one end side of the impeller cylinder portion in the axial direction and fixes the shaft and the impeller to each other. The shaft includes a step surface at the other end of the one end portion of the shaft in the axial direction. The other end surface of the impeller cylinder portion faces the step surface in the axial direction. The impeller includes a convex portion protruding in the axial direction on at least one of one end surface and the other end surface of the impeller cylinder portion in the axial direction. The convex portion is in contact with the fixing member or the step surface.

### CROSS REFERENCE TO RELATED APPLICATIONS

This application claims the benefit of priority to Japanese Patent Application No. 2017-131827 filed on Jul. 5, 2017. The entire contents of this application are hereby incorporated herein by reference.

### BACKGROUND OF THE INVENTION

### 1. Field of the Invention

The present disclosure relates to a vane wheel and a blowing device.

### 2. Description of the Related Art

Japanese Unexamined Patent Application Publication No. 2017-44126 discloses a rotating machine which prevents the attachment of an impeller from loosening and effectively prevents the impeller from falling off from a rotation shaft. An extremely low-temperature rotating machine of Japanese Unexamined Patent Application Publication No. 2017-44126 is provided with an impeller which moves a main refrigerant by rotation and a rotation shaft provided with a tip portion which penetrates the impeller and is screwed into the impeller. A fastening rotation direction of the impeller which is screwed into the rotation shaft is a backward rotation direction which is the reverse of a forward rotation direction in which the main refrigerant is moved, and a shaft tip piece, which restricts the rotation of the impeller when the impeller receives a force in the forward rotation direction, is attached to the tip portion.

In a case in which the impeller is fixed to a shaft using a screw, there is a possibility of cracks being generated in the impeller by the force which is applied to the impeller by the fastening of the screw.

### SUMMARY OF THE INVENTION

Accordingly, it is an object of the present disclosure to provide a technology capable of suppressing the generation of cracks in an impeller.

An exemplary vane wheel of the present disclosure includes a shaft which is disposed along a center axis, an impeller, and a fixing member. The impeller includes an impeller cylinder portion into which one end portion of the shaft in the axial direction is inserted. The fixing member is disposed on one end side of the impeller cylinder portion in the axial direction and fixes the shaft and the impeller to each other. The shaft includes a step surface which is a flat surface spreading outward in a radial direction at the other end of the one end portion of the shaft in the axial direction. The other end surface of the impeller cylinder portion in the axial direction faces the step surface in the axial direction. The impeller includes a convex portion which protrudes in the axial direction on at least one of one end surface and the other end surface of the impeller cylinder portion in the axial direction. The convex portion is in contact with the fixing member or the step surface.

An exemplary blowing device of the present disclosure includes the vane wheel.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view of a vacuum cleaner according to an embodiment of the present disclosure.

FIG. 2 is a perspective view of a blowing device according to the embodiment of the present disclosure.

FIG. 3 is a vertical sectional view of the blowing device according to the embodiment of the present disclosure

FIG. 4 is a perspective view of a vane wheel according to the embodiment of the present disclosure.

FIG. 5 is a vertical sectional view of the vane wheel according to the embodiment of the present disclosure.

FIG. 6 is a schematic plan view of an impeller cylinder portion as viewed from below in an axial direction.

FIG. 7 is a view for explaining a first modification example of the vane wheel according to the embodiment of the present disclosure.

FIG. 8 is a view for explaining a second modification example of the vane wheel according to the embodiment of the present disclosure.

FIG. 9 is a view for explaining a third modification example of the vane wheel according to the embodiment of the present disclosure.

FIG. 10 is a view for explaining another aspect of the third modification example of the vane wheel according to the embodiment of the present disclosure.

FIG. 11 is a view for explaining a fourth modification example of the vane wheel according to the embodiment of the present disclosure.

### DETAILED DESCRIPTION OF THE PREFERRED EMBODIMENTS

Hereinafter, a detailed description will be given of the exemplary embodiments of the present disclosure with reference to the drawings. In this specification, in a vane wheel 1 and a blowing device 100, a direction parallel to a center axis C of the vane wheel 1 is referred to as an “axial direction”, a direction orthogonal to the center axis C of the vane wheel 1 is referred to as a “radial direction”, and a direction going along an arc centered on the center axis C of the vane wheel 1 is referred to as a “circumferential direction”.

In this specification, a description will be given of shapes and positional relationships of respective parts in the blowing device 100 where the axial direction is an up-down direction and the side of an impeller 11 is up with respect to a motor 2. The up-down direction is a name simply used for explanation and does not restrict the actual positional relationships and directions.

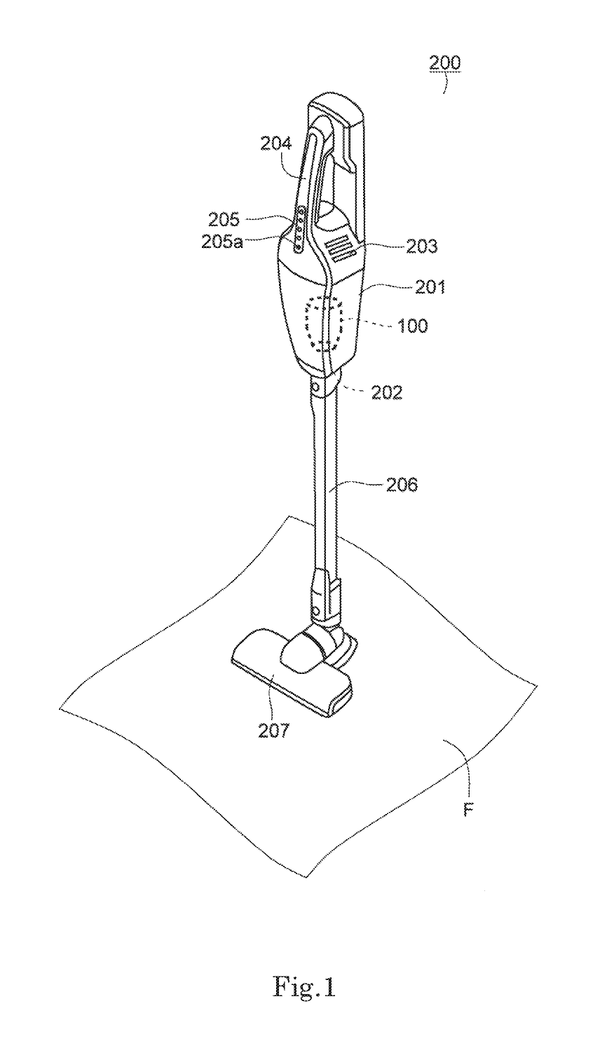

In this specification, a description will be given of shapes and positional relationships of respective parts in a vacuum cleaner 200 where a direction approaching a floor surface F (a cleaning target surface) of FIG. 1 is “downward” and a direction separating from the floor surface F is “upward”. These directions are names simply used for explanation and do not restrict the actual positional relationships and directions.

The terms “upstream” and “downstream” indicate the upstream and the downstream in a flow direction of air which is sucked in from a gas inlet 102 when the vane wheel 1 is rotated.

Hereinafter, a description will be given of the vacuum cleaner on which the blowing device 100 having the vane wheel 1 of the exemplary embodiment of the present disclosure is mounted. FIG. 1 is a perspective view of the vacuum cleaner 200 according to an embodiment of the present disclosure. The vacuum cleaner 200 is a stick type electric vacuum cleaner. The vacuum cleaner 200 includes a casing 201 which is provided with a gas suction portion 202 and a gas discharging portion 203 on the bottom surface and the top surface, respectively. A power cord (not illustrated) is routed out from the rear surface of the casing 201. The power cord is connected to a power outlet (not illustrated) which is provided on a side wall surface of a room and supplies power to the vacuum cleaner 200. The vacuum cleaner 200 may be a robot type, a canister type, or a handy type electric vacuum cleaner.

An air path (not illustrated) which communicates the gas suction portion 202 with the gas discharging portion 203 is formed inside the casing 201. A waste collection unit (not illustrated), a filter (not illustrated), and the blowing device 100 are disposed in order from the upstream side toward the downstream side inside the air path. Refuse such as dust contained in the air which flows inside the air path is captured by the filter and collected inside the waste collection unit which is formed in a container shape. The waste collection unit and the filter are configured to be attachable to and detachable from the casing 201.

A grip portion 204 and an operation portion 205 are provided on the top portion of the casing 201. The user is capable of gripping the grip portion 204 and moving the vacuum cleaner 200. The operation portion 205 includes a plurality of buttons 205a. The user performs operation settings of the vacuum cleaner 200 by operating the buttons 205a. For example, driving start, driving stop, modifying revolution rate and the like of the blowing device 100 are instructed by the operation of the buttons 205a. A rod-shaped suction tube 206 is connected to the gas suction portion 202. A suction nozzle 207 is attached to the upstream end of the suction tube 206 to be attachable to and detachable from the suction tube 206. The upstream end of the suction tube 206 is the bottom end of the suction tube 206 in FIG. 1.

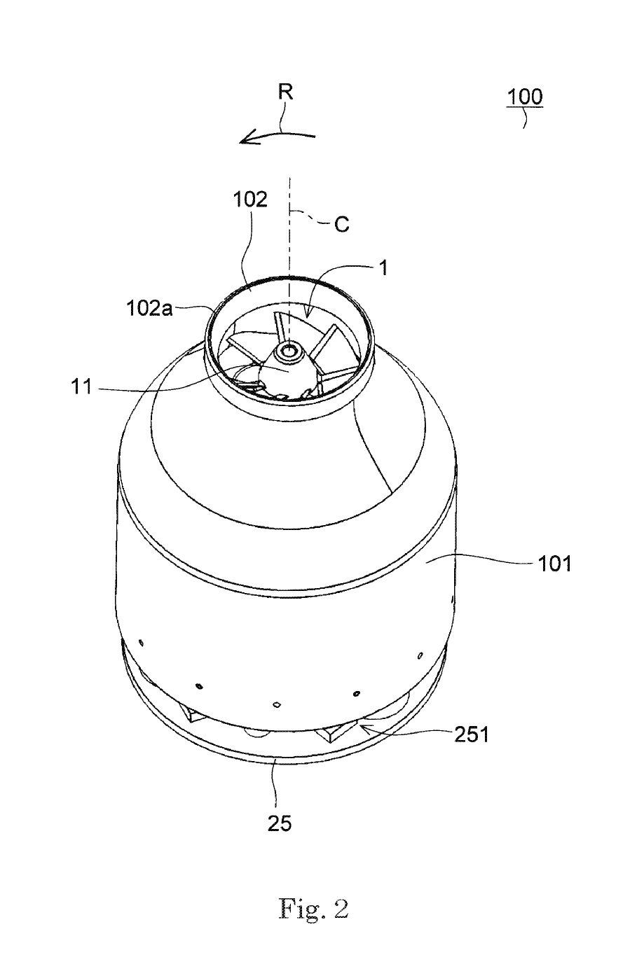

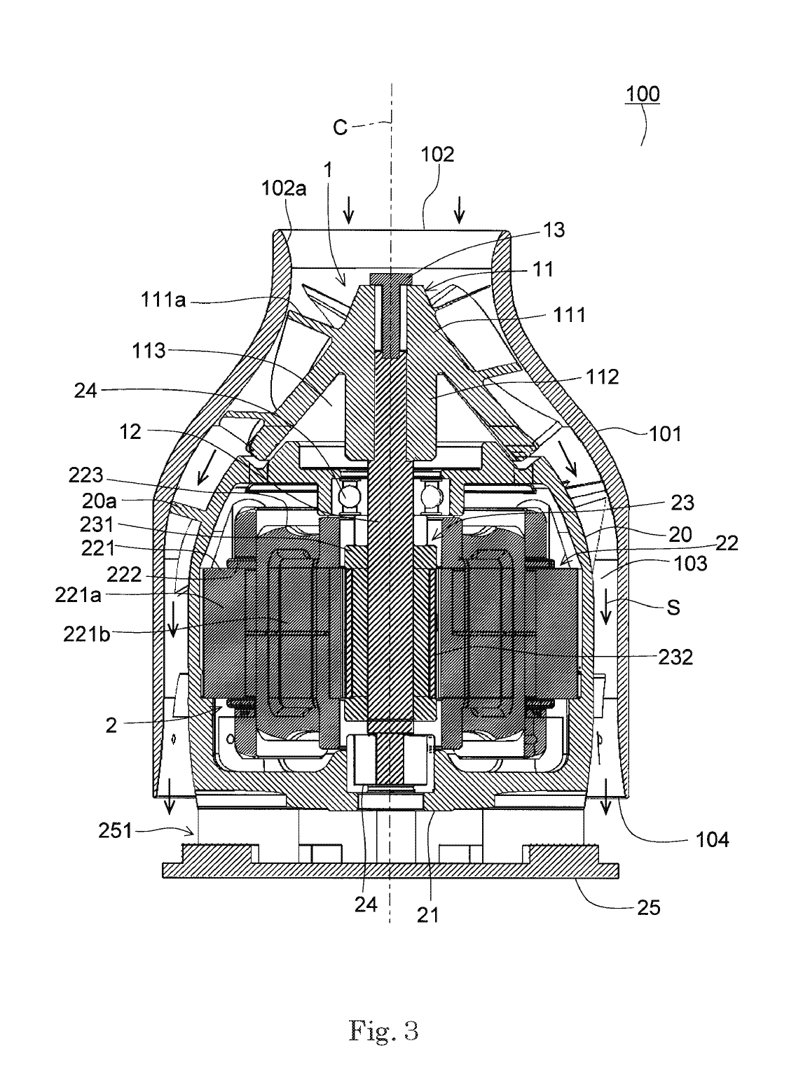

FIG. 2 is a perspective view of the blowing device 100 according to the embodiment of the present disclosure. FIG. 3 is a vertical sectional view of the blowing device 100 according to the embodiment of the present disclosure. The blowing device 100 is mounted on the vacuum cleaner 200 and sucks the air. The blowing device 100 includes the vane wheel 1.

The blowing device 100 includes a cylindrical fan casing 101, the horizontal cross-section of which is circular. The vane wheel 1 and the motor 2 are stored in the fan casing 101. The gas inlet 102 which is open in the up-down direction is provided in the top portion of the fan casing 101. A bellmouth 102a which is inclined from the top end to the inside in the radial direction and extends downward is provided on the gas inlet 102. Accordingly, the diameter of the gas inlet 102 smoothly decreases in size going from the top toward the bottom. The bottom surface of the fan casing 101 is open in the up-down direction.

The vane wheel 1 which includes the impeller 11 is joined to the motor 2 which is disposed under the impeller 11. According to driving of the motor 2, the vane wheel 1 rotates centered on the center axis C which extends vertically. In the present embodiment, the vane wheel 1 rotates in a rotation direction R illustrated in FIG. 2. A detailed description of the vane wheel 1 will be given later.

The motor 2 includes a cylindrical motor housing 20, the horizontal cross-section of which is circular. A flow path 103 is formed in the gap between the fan casing 101 and the motor housing 20. The flow path 103 communicates with the impeller 11 on the top end (the upstream end) and an exhaust port 104 is formed in the bottom end (the downstream end) of the flow path 103. A disc-shaped bottom cover 21 is disposed under a stator 22 (described later). The bottom surface of the motor housing 20 is covered by the bottom cover 21. The bottom cover 21 is attached to the motor housing 20 using a screw (not illustrated).

A plurality of stator blades 20a are provided on an outer circumferential surface of the motor housing 20 to line up in the circumferential direction. The stator blades 20a are configured to be plate-shaped. The stator blades 20a are inclined toward the direction opposite from the rotation direction R of the vane wheel 1 while going upward. The stator blades 20a are curved such that the top sides are convex. The outside edges of the plurality of stator blades 20a are in contact with the inner surface of the fan casing 101. The stator blades 20a guide an airflow downward as illustrated by an arrow S using the driving of the blowing device 100.

The motor 2 is an inner rotor type motor and includes the stator 22, a rotor 23, bearing portions 24, and a circuit board 25.

The stator 22 is disposed on the outside of the rotor 23 in the radial direction. The stator 22 includes a stator core 221 and an insulator 222. The stator core 221 consists of a laminated steel plate in which electromagnetic steel plates are laminated in the axial direction. The stator core 221 includes an annular core back 221a and a plurality of teeth 221b. The plurality of teeth 221b are formed to extend radially inward in the radial direction from an inner circumferential surface of the core back 221a. The plurality of teeth 221b are arranged at an equal interval in the circumferential direction.

The insulator 222 is composed of an insulating material such as a resin and covers at least a portion of the stator core 221. A coil 223 is configured by winding a conducting wire around the teeth 221b with the insulator 222 in between. In other words, the insulator 222 is disposed between the coil 223 and the teeth 221b. The teeth 221b and the coil 223 are insulated by the insulator 222.

The rotor 23 includes a cylindrical rotor housing 231 and a plurality of magnets 232. The rotor housing 231 holds a shaft 12 of the vane wheel 1. The plurality of magnets 232 are disposed on an outer circumferential surface of the rotor housing 231. The surface on the outside of each of the magnets 232 in the radial direction faces the end surface of the inside of each of the teeth 221b in the radial direction. The plurality of magnets 232 are disposed at an equal interval in the circumferential direction such that N pole magnetic surfaces and S pole magnetic surfaces are lined up alternately. A single ring-shaped magnet may be used instead of the plurality of magnets 232. In this case, an outer circumferential surface of the magnet may be magnetized such that the N pole and the S pole alternate in the circumferential direction. The magnet and the rotor housing may be formed integrally using a resin which is combined with a magnetic powder.

The shaft 12 which is held by the rotor housing 231 is supported by the upper and lower bearing portions 24 to be rotatable and rotates together with the rotor 23 centered on the center axis C. The rotation direction is the rotation direction R illustrated in FIG. 2. The upper bearing portion 24 is supported by the center portion of the top portion of the motor housing 20. The lower bearing portion 24 is supported by the center portion of the bottom cover 21. In the present embodiment, the upper bearing portion 24 includes ball bearings and the lower bearing portion 24 includes a slide bearing. The upper and lower bearing portions 24 may include other types of bearing. For example, the upper and lower bearing portions 24 may both include ball bearings.

The circuit board 25 is disposed under the bottom cover 21. The circuit board 25 is circular and is formed of a resin such as an epoxy resin, for example. Electronic components 251 are disposed on the circuit board 25. The electronic components 251 include an AC/DC converter, an inverter, a control circuit, and the like. The circuit board 25 is electrically connected to the stator 22 by a connection terminal (not illustrated). Alternating current power which is supplied from a commercial power source is transformed into direct current power and the motor 2 is driven by the power being supplied to the coil 223 via the inverter. The blowing device 100 causes the vane wheel 1 to rotate using the driving of the motor 2 and generates an airflow.

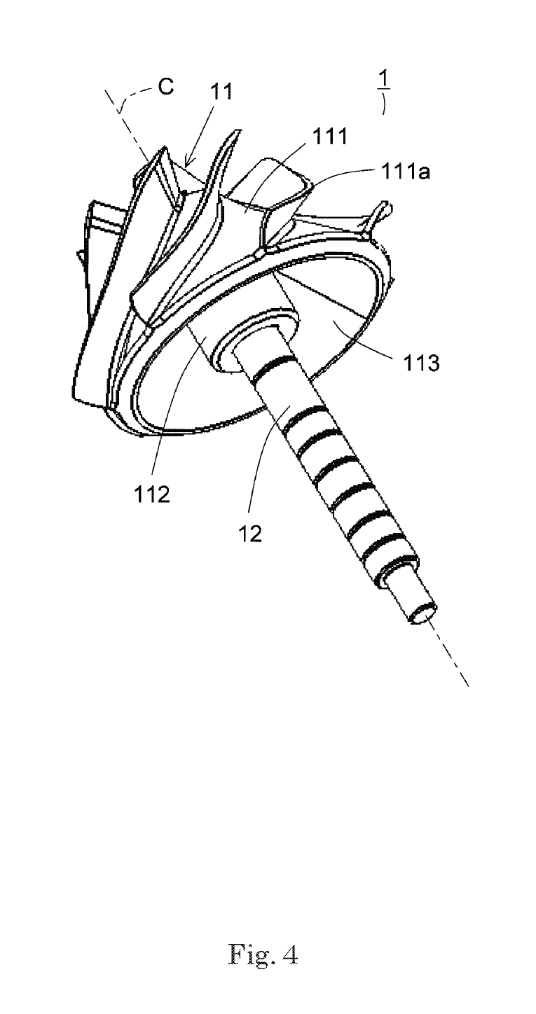

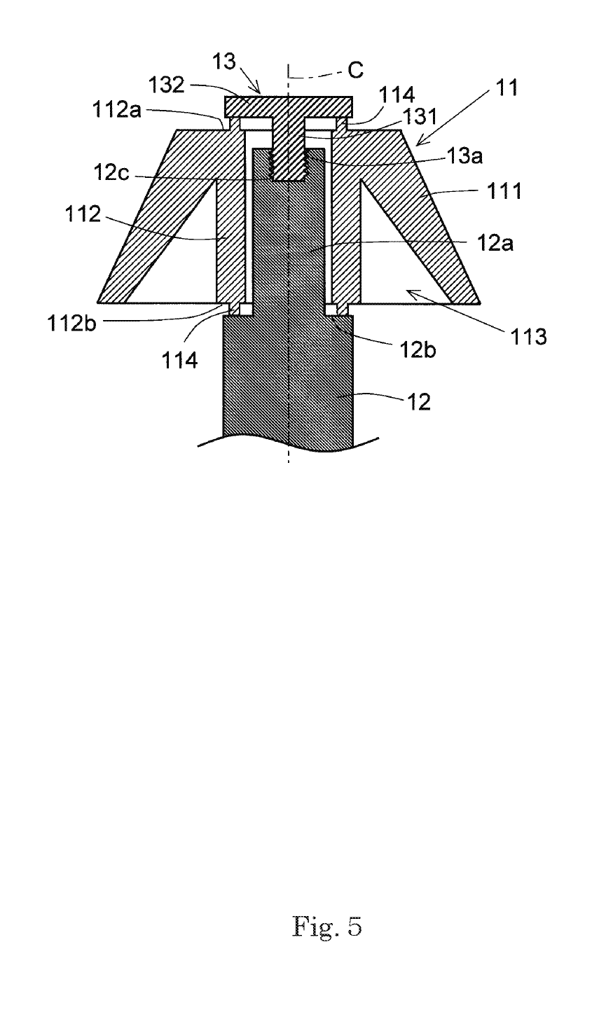

FIG. 4 is a perspective view of the vane wheel 1 according to the embodiment of the present disclosure. FIG. 5 is a vertical sectional view of the vane wheel 1 according to the embodiment of the present disclosure. FIG. 5 schematically illustrates a portion of the vane wheel 1. As illustrated in FIGS. 4 and 5, the vane wheel 1 includes the impeller 11, the shaft 12, and a fixing member 13.

The impeller 11 is a diagonal flow impeller. In the present embodiment, the impeller 11 is formed by casting using an aluminum alloy. However, the impeller 11 may be formed using other metals. The impeller 11 is not limited to being made of metal and may be made of a resin. It is preferable for the impeller 11 to be a cast product in order to improve durability during high-speed rotation. In the high-speed rotation, the impeller 11 rotates at a rotation speed of greater than or equal to 100,000 rpm, for example. As illustrated in FIG. 3, in the blowing device 100, the top end portion of the impeller 11 is disposed at approximately the same height as the bottom end of the bellmouth 102a. The impeller 11 includes an impeller base portion 111, an impeller cylinder portion 112, and a gap portion 113.

The impeller base portion 111 includes a plurality of vanes 111a on an outer circumferential surface. In the present embodiment, the impeller base portion 111 is a truncated cone shape. In detail, the diameter of the impeller base portion 111 increases in size going downward. The bottom end portion of the impeller base portion 111 is open. A shape of the opening is circular in plan view from the axial direction. The plurality of vanes 111a are disposed to line up in the circumferential direction on the outer circumferential surface of the impeller base portion 111. In each of the vanes 111a, the top portion of the vane 111a is positioned in front of the bottom portion of the vane 111a in the rotation direction R.

The impeller cylinder portion 112 is positioned inside the impeller base portion 111 in the radial direction. One end portion of the shaft 12 in the axial direction is inserted into the impeller cylinder portion 112. In the present embodiment, a top end portion 12a of the shaft 12 is inserted into the impeller cylinder portion 112. The impeller cylinder portion 112 extends from the bottom end to the top end of the impeller 11. At least a portion of the top end surface of the impeller 11 is formed on the top end surface of the impeller cylinder portion 112 (the one end surface in the axial direction). The entirety of the top end surface of the impeller 11 may be composed of the top end surface of the impeller cylinder portion 112.

In the present embodiment, the impeller cylinder portion 112 has a circular external shape in plan view from the axial direction. However, the external shape of the impeller cylinder portion 112 is not limited to being circular and may be another shape such as polygonal or elliptical. For example, the external shape of the impeller cylinder portion 112 may be a different shape at the top portion and the bottom portion. It is possible to reduce air resistance by rendering the external shape of the impeller cylinder portion 112 circular. In the present embodiment, although the inner circumferential surface of the impeller cylinder portion 112 is circular in plan view from the axial direction, the inner circumferential surface may be another shape such as an ellipse, for example.

The gap portion 113 is positioned between the impeller base portion 111 and the impeller cylinder portion 112 in the radial direction. The width of the gap portion 113 in the radial direction becomes smaller from the bottom toward the top of the impeller cylinder portion 112.

The shaft 12 is disposed along the center axis C. In the present embodiment, the shaft 12 is circular in plan view from the axial direction. However, shaft 12 may be a shape other than a circular shape, for example, may be elliptical or the like. The shaft 12 may be columnar or cylindrical. In the present embodiment, the shaft 12 is made of metal, and in detail, is made of stainless steel.

As illustrated in FIG. 5, the shaft 12 includes a step surface 12b. The step surface 12b is a flat surface which spreads outward in the radial direction at the other end of the one end portion of the shaft 12 in the axial direction. In the present embodiment, the step surface 12b is a flat surface which spreads outward in the radial direction at the bottom end of the top end portion 12a of the shaft 12. The diameter of the shaft 12 changes with the step surface 12b serving as a boundary. The shaft 12 on the top side of the step surface 12b has a small diameter in comparison to the shaft 12 on the bottom side of the step surface 12b. The portion of the shaft 12 which is on the top side of the step surface 12b and has a small diameter is inserted into the impeller cylinder portion 112. The portion of the shaft 12 which is inserted into the impeller cylinder portion 112 corresponds to the top end portion (the one end portion in the axial direction) 12a of the shaft 12.

The other end surface of the impeller cylinder portion 112 in the axial direction faces the step surface 12b in the axial direction. In the present embodiment, a bottom end surface 112b of the impeller cylinder portion 112 faces the step surface 12b in the axial direction. The diameter of the bottom end surface 112b of the impeller cylinder portion 112 may be bigger than, smaller than, or the same as the diameter of the shaft 12 at the position of the step surface 12b.

As illustrated in FIG. 5, the fixing member 13 is disposed on one end side of the impeller cylinder portion 112 in the axial direction. The fixing member 13 fixes the shaft 12 and the impeller 11 to each other. In the present embodiment, the fixing member 13 is disposed on a top end side of the impeller cylinder portion 112. In detail, the fixing member 13 includes a shaft portion 131 and a head portion 132. The shaft portion 131 includes a screw thread 13a which extends in the up-down direction and serves as a male screw on an outer circumferential surface. The head portion 132 is disposed on a top end side of the shaft portion 131. The head portion 132 has a larger diameter than the shaft portion 131. The head portion 132 may be circular, hexagonal, or the like in plan view from the axial direction. The fixing member 13 is a bolt or a screw.

A screw hole 12c in which a groove for accepting the screw thread 13a of the fixing member 13 is cut into the inner circumferential surface is provided on a top end surface of the shaft 12. The fixing member 13 is fastened in a state in which the fixing member 13 is accepted by the screw hole 12c. Accordingly, the impeller 11 is interposed between the bottom surface of the head portion 132 and the step surface 12b and is fixed to the shaft 12.

In the present embodiment, the fixing member 13 includes the screw thread 13a in a direction in which the fixing member 13 is fastened by the rotation of the impeller 11. The fastening direction of the fixing member 13 is the opposite direction from the rotation direction R of the impeller 11. Accordingly, it is possible to prevent the fixing member 13 from being loosened by the rotation of the impeller 11 and it is possible to prevent the impeller 11 from coming out from the shaft 12.

As illustrated in FIG. 5, the impeller 11 includes a convex portion 114 which protrudes in the axial direction on at least one of the one end surface and the other end surface of the impeller cylinder portion 112 in the axial direction. In the present embodiment, the impeller 11 includes the convex portion 114 which protrudes upward on a top end surface 112a of the impeller cylinder portion 112. The impeller 11 includes the convex portion 114 which protrudes downward on the bottom end surface 112b of the impeller cylinder portion 112.

The convex portions 114 are in contact with the fixing member 13 or the step surface 12b. In detail, the convex portion 114 which is provided on the top end surface 112a of the impeller cylinder portion 112 is in contact with the bottom surface of the head portion 132. The convex portion 114 which is provided on the bottom end surface 112b of the impeller cylinder portion 112 is in contact with the step surface 12b.

In the present embodiment, the outer end portion of each of the convex portions 114 in the radial direction is positioned inside the outer end portion of the fixing member 13 or the step surface 12b in the radial direction. In detail, the convex portion 114 which is provided on the top end surface 112a of the impeller cylinder portion 112 is positioned inside the outer end portion of the head portion 132 in the radial direction. The convex portion 114 which is provided on the bottom end surface 112b of the impeller cylinder portion 112 is positioned inside the outer end portion of the step surface 12b in the radial direction. Accordingly, it is possible to cause the convex portion 114 to contact the fixing member 13 or to cause the convex portion 114 to contact the step surface 12b without widening the width of the convex portion 114 too much in the radial direction. Therefore, in a case in which the convex portions 114 receive a force in the axial direction, it is possible to render the convex portions 114 capable of easily deforming. It is possible to render the convex portions 114 capable of easily absorbing stress.

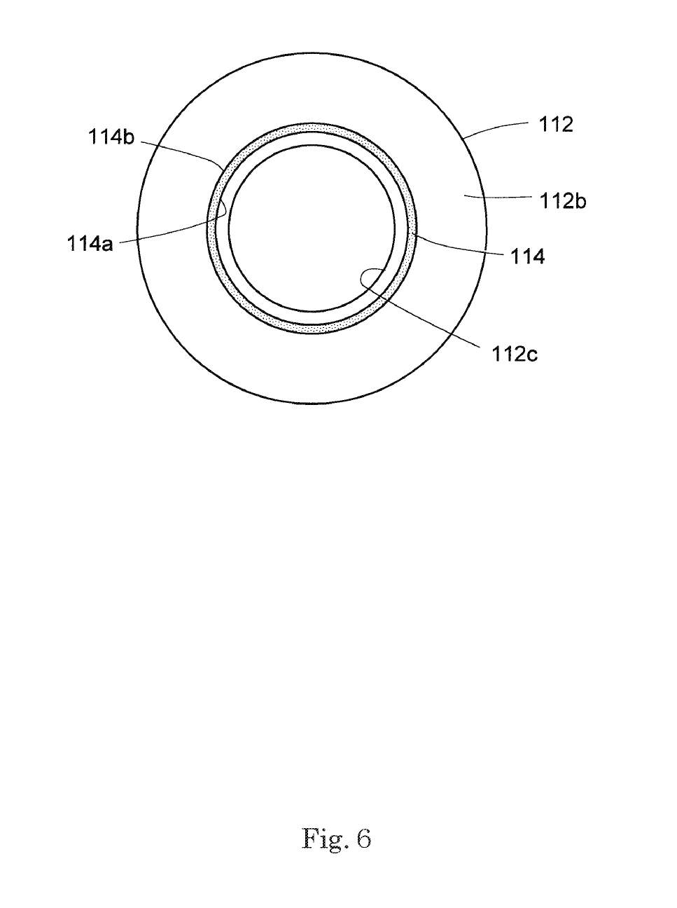

FIG. 6 is a schematic plan view of the impeller cylinder portion 112 as viewed from below in the axial direction. As illustrated in FIG. 6, the convex portions 114 have a ring shape which continues in the circumferential direction. The convex portion 114 illustrated in FIG. 6 is the convex portion 114 which is provided on the bottom end surface 112b of the impeller cylinder portion 112. Although not illustrated, in the present embodiment, the convex portion 114 which is provided on the top end surface 112a of the impeller cylinder portion 112 also has a ring shape which continues in the circumferential direction. In a case in which the convex portions 114 are ring-shaped, it is possible to increase the contact area between the convex portion 114 and the fixing member 13 and the convex portion 114 and the step surface 12b in the circumferential direction and it is possible to render the fixing of the impeller 11 to the shaft 12 firm.

As illustrated in FIG. 6, in the present embodiment, the inner circumferential surface 114a of the convex portion 114 is positioned outside an inner circumferential surface 112c of the impeller cylinder portion 112 in the radial direction. As described above, outer circumferential surfaces 114b of the convex portions 114 are positioned inside the outer end portions of the fixing member 13 and the step surface 12b in the radial direction. In other words, the convex portions 114 have a narrow width in the radial direction and are ring-shaped. Therefore, in a case in which the convex portions 114 receive a force in the axial direction, the convex portions 114 easily deform. In a case in which the inner circumferential surface 114a of the convex portion 114 is configured to be positioned, in the radial direction, outside the inner circumferential surface 112c of the impeller cylinder portion 112, it is possible to prevent the convex portion 114 which receives a force in the axial direction and deforms from protruding inside the inner circumferential surface 112c of the impeller cylinder portion 112.

The lengths of the convex portions 114 in the axial direction may be lengths of a degree at which the convex portions 114 are capable of deforming in a case in which the convex portions 114 receive a force in the axial direction. In consideration of reducing the size of the device and the like, it is preferable that the lengths of the convex portions 114 in the axial direction not be too long. The inner circumferential surfaces 114a of the convex portions 114 may have the same position as the inner circumferential surface 112c of the impeller cylinder portion 112 in the radial direction. The outer circumferential surfaces 114b of the convex portions 114 may have the same positions in the radial direction as the outer end portions of the fixing member 13 and the step surface 12b in the radial direction. The outer circumferential surfaces 114b of the convex portions 114 may be positioned, in the radial direction, outside the outer end portions of the fixing member 13 and the step surface 12b in the radial direction.

In the vane wheel 1 of the present embodiment, it is possible to sandwich the impeller 11 between the fixing member 13 and the step surface 12b and fix the impeller 11 to the shaft 12 by fastening the fixing member 13 and applying a force in the axial direction. During the fastening using the fixing member 13, the impeller 11 causes the convex portions 114 to contact the fixing member 13 and the step surface 12b. Therefore, in a case in which a force is applied to the impeller cylinder portion 112 in the axial direction by the fastening of the fixing member 13, it is possible to absorb the force in the axial direction using the deformation of the convex portions 114. As a result, it is possible to suppress the generation of cracks in the impeller 11 accompanying the fastening of the fixing member 13. Since it is possible to suppress the generation of cracks in the impeller 11 during the manufacturing, it is possible to efficiently manufacture the blowing device 100 which includes the vane wheel 1 of the present embodiment.

In the above description, a configuration is adopted in which the impeller cylinder portion 112 is provided with the convex portions 114 on both the top end surface 112a and the bottom end surface 112b. However, the convex portion 114 may be provided on only one of the top end surface 112a and the bottom end surface 112b of the impeller cylinder portion 112. Even in this case, it is possible to absorb the force which is applied to the impeller cylinder portion 112 in the axial direction by the fastening of the fixing member 13 using the convex portion 114. Therefore, it is possible to suppress the generation of cracks in the impeller 11 accompanying the fastening of the fixing member 13.

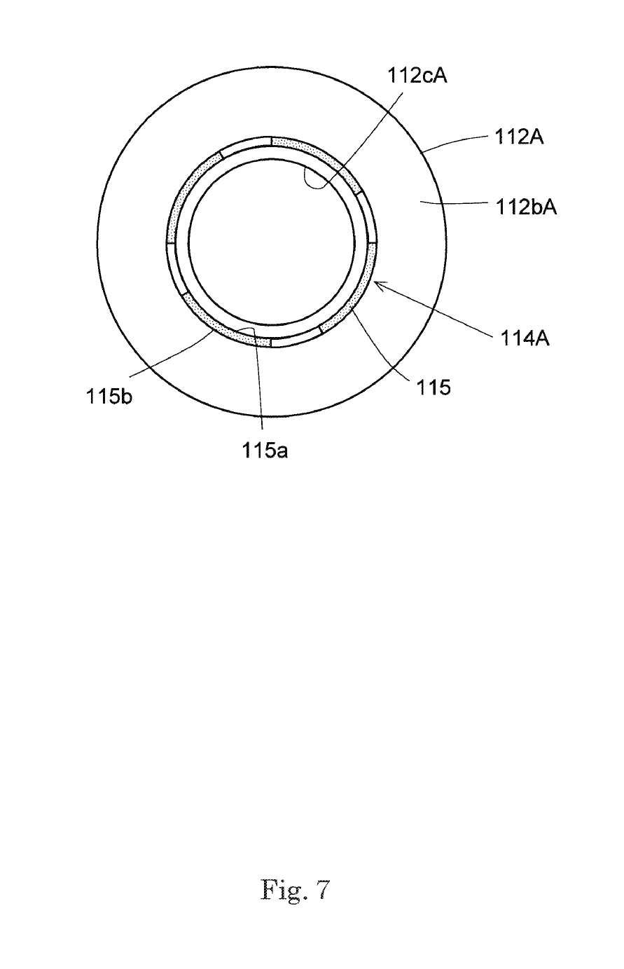

FIG. 7 is a view for explaining a first modification example of the vane wheel 1 according to the embodiment of the present disclosure. In detail, FIG. 7 is a schematic plan view of an impeller cylinder portion 112A as viewed from below in the axial direction. In the first modification example, a convex portion 114A which is provided on a bottom end surface 112bA of the impeller cylinder portion 112A includes a plurality of arc-shaped portions 115 which are arranged with an interval in the circumferential direction. In this modification example, a top end surface of the impeller cylinder portion 112A is also provided with the similar convex portion 114A.

In this modification example, the plurality of arc-shaped portions 115 are arranged at an equal interval in the circumferential direction. In this modification example, although the number of the arc-shaped portions 115 is four, the number may be changed. The number of the plurality of arc-shaped portions 115 may be greater than or equal to two.

In this modification example, an inner circumferential surface 115a of each of the arc-shaped portions 115 is positioned outside an inner circumferential surface 112cA of the impeller cylinder portion 112A in the radial direction. An outer circumferential surface 115b of each of the arc-shaped portions 115 is positioned inside the outer end portion of the fixing member 13 and the step surface 12b in the radial direction. In other words, the arc-shaped portions 115 are configured to have a narrow width in the radial direction. Therefore, in a case in which the arc-shaped portions 115 receive a force in the axial direction, the arc-shaped portions 115 easily deform.

In this modification example, it is possible to absorb the force which is applied to the impeller cylinder portion 112A in the axial direction by the fastening of the fixing member 13 using the arc-shaped portions 115. Therefore, it is possible to suppress the generation of cracks in the impeller accompanying the fastening of the fixing member 13.

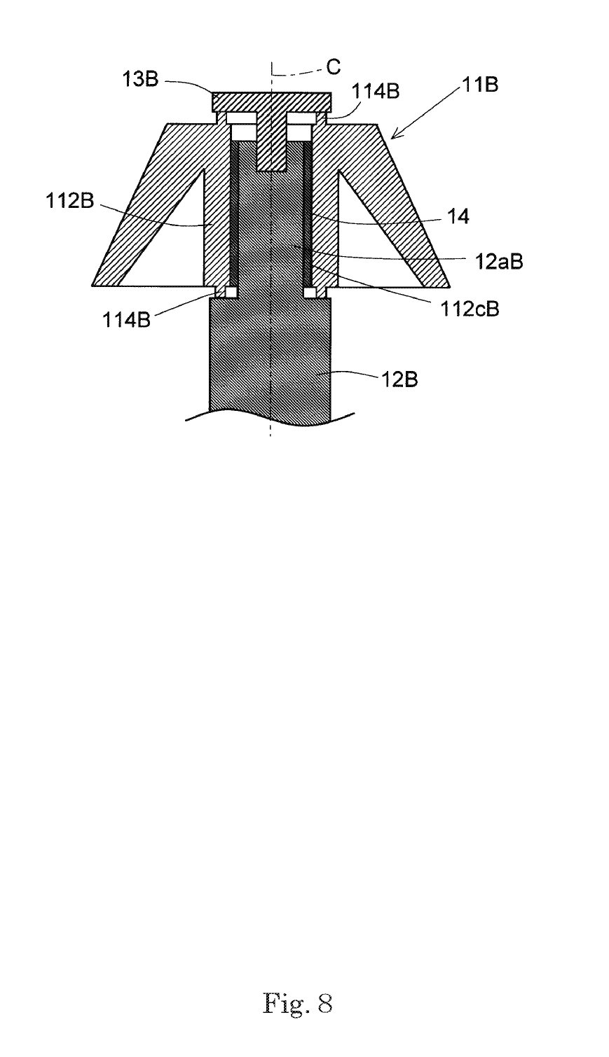

FIG. 8 is a view for explaining a second modification example of the vane wheel 1 according to the embodiment of the present disclosure. In detail, FIG. 8 is a view schematically illustrating a vertical cross section of a portion of the vane wheel. In the second modification example, a shaft 12B is fixed to an impeller cylinder portion 112B by an adhesive 14. The adhesive 14 may be composed of an epoxy-based resin or the like, for example. In this modification example, the top end surface and the bottom end surface of the impeller cylinder portion 112B are provided with a convex portions 114B.

In this modification example, the adhesive 14 is disposed on at least a portion of the space between an outer circumferential surface of a top end portion 12aB of the shaft 12B and an inner circumferential surface 112cB of the impeller cylinder portion 112B. The adhesive 14 connects the outer circumferential surface of the top end portion 12aB of the shaft 12B to the inner circumferential surface 112cB of the impeller cylinder portion 112B. For example, the adhesive 14 may be applied to the inner circumferential surface 112cB of the impeller cylinder portion 112B before inserting the shaft 12B and may be cured after the shaft 12B is inserted into the impeller cylinder portion 112B.

According to the configuration of this modification example, in addition to the fixing of an impeller 11B and the shaft 12B to each other using a fixing member 13B, the impeller 11B and the shaft 12B are fixed to each other using the adhesive 14. Therefore, it is possible to firmly fix the impeller 11B and the shaft 12B to each other.

In the embodiment described above, a configuration is adopted in which the one end portion (the top end portion 12a) of the shaft 12 in the axial direction is inserted into the impeller cylinder portion 112. A configuration may be adopted in which the one end portion of the shaft 12 in the axial direction is press-fitted into the impeller cylinder portion 112. In this case, in addition to the fixing by the fixing member 13, it is also possible to fix the impeller 11 and the shaft 12 to each other using the press-fitting. Therefore, it is possible to render the fixing between the impeller 11 and the shaft 12 firm.

It is preferable that, in a case in which the shaft 12 is press-fitted into the impeller cylinder portion 112, at least a portion of one end portion of the shaft 12 in the axial direction faces the impeller base portion 111 in the radial direction with the gap portion 113 in between (refer to FIG. 5). It is favorable for the entirety of the one end portion of the shaft 12 in the axial direction to face the impeller base portion 111 with the gap portion 113 in between. Accordingly, it is possible to suppress the force which is applied from the shaft 12 to the impeller cylinder portion 112 to be transmitted to the impeller base portion 111 by the pressing. Therefore, it is possible to prevent the deformation of the vanes 111a which are provided on the impeller base portion 111 together with the pressing of the shaft 12.

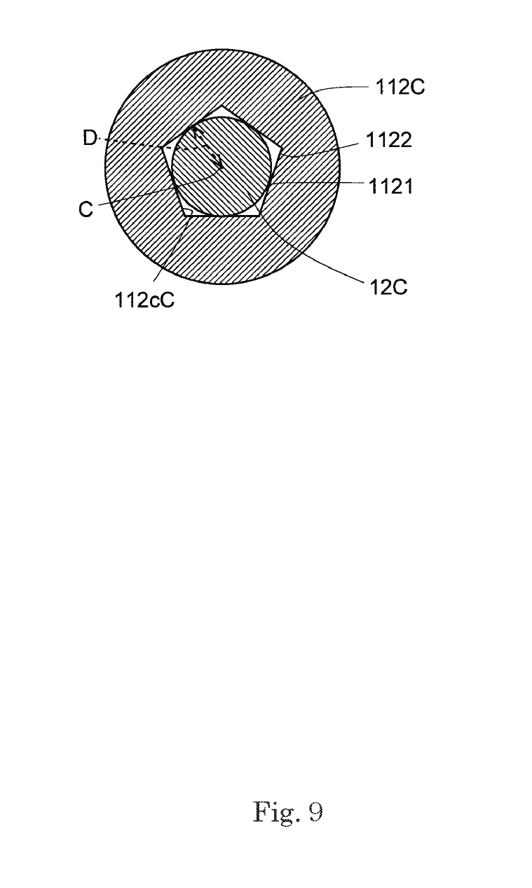

In a third modification example, as illustrated later in FIG. 9, a shaft 12C is pressed into an impeller cylinder portion 112C. Hereinafter, a description will be given of a configuration example of the impeller cylinder portion 112C of a case in which the shaft 12C is press-fitted into the impeller cylinder portion 112C.

FIG. 9 is a view for explaining the third modification example of the vane wheel 1 according to the embodiment of the present disclosure. In detail, FIG. 9 is a lateral sectional view illustrating a relationship between the impeller cylinder portion 112C and the shaft 12C. As illustrated in FIG. 9, the impeller cylinder portion 112C includes a plurality of first portions 1121 and a plurality of second portions 1122 on an inner circumferential surface 112cC. The plurality of first portions 1121 are disposed with an interval in the circumferential direction and are in contact with the shaft 12C to fix the shaft 12C. The plurality of second portions 1122 face the shaft 12C, with an interval therebetween in the radial direction, and each is positioned between two of the first portions 1121 which are adjacent in the circumferential direction. In other words, one second portion 1122 is positioned between two of the first portions 1121 which are adjacent in the circumferential direction.

In this modification example, the shaft 12C is press-fitted to the plurality of first portions 1121. In other words, the first portions 1121 are zones in which the shaft 12C is pressed into the impeller cylinder portion 112C. The second portions 1122 are zones in which the shaft 12C is not pressed into the impeller cylinder portion 112C. In detail, the plurality of first portions 1121 are disposed at a substantially equal interval in the circumferential direction. Each of the plurality of second portions 1122 is interposed between two of the first portions 1121 which are adjacent in the circumferential direction. It is preferable that the shaft 12C be fixed through strong pressing into the plurality of first portions 1121 in order to firmly hold the impeller which rotates at high speed.

In this modification example, the shaft 12C is press-fitted to a portion of the inner circumferential surface 112cC of the impeller cylinder portion 112C in the circumferential direction and is not in contact with the remaining portions. According to the presence of the portions which are not press-fitted, it is possible to distribute the pressing stress which is generated in the impeller cylinder portion 112 in a case in which the shaft 12C is pressed into the impeller cylinder portion 112C. As a result, it is possible to suppress the generation of cracks in the impeller using the pressing of the shaft 12C.

In detail, as illustrated in FIG. 9, it is preferable that the inner circumferential surface 112cC of the impeller cylinder portion 112C be polygonal in plan view from the axial direction. In the example illustrated in FIG. 9, although the inner circumferential surface 112cC of the impeller cylinder portion 112C is pentagonal, the inner circumferential surface 112cC may be another polygonal shape. The inner circumferential surface 112cC of the impeller cylinder portion 112 may be elliptical.

The first portion 1121 includes a portion of the inner circumferential surface 112cC of the impeller cylinder portion 112C at which a radial direction distance D from the center axis C is minimal. The second portions 1122 include peak portions of the regular pentagon. In a case in which the inner circumferential surface 112cC of the impeller cylinder portion 112C is polygonal, the peak portions of the polygon are not necessarily pointed and may be rounded off. The lines which join the adjacent peak portions of the polygon are not necessarily straight lines and may be curved.

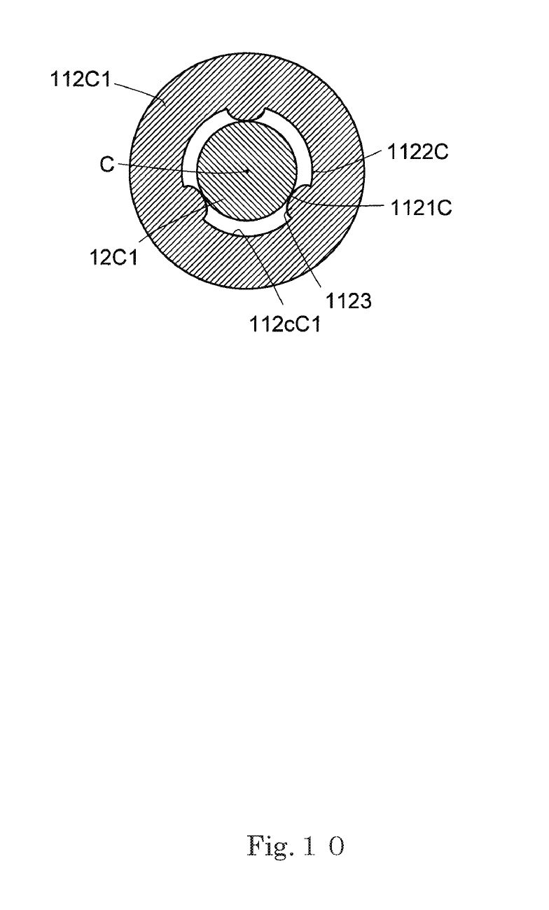

FIG. 10 is a view for explaining another aspect of the third modification example of the vane wheel 1 according to the embodiment of the present disclosure. In detail, FIG. 10 is a lateral sectional view illustrating a relationship between an impeller cylinder portion 112C1 and a shaft 12C1. Even in the configuration illustrated in FIG. 10, the impeller cylinder portion 112C1 includes a plurality of first portions 1121C and a plurality of second portions 1122C on an inner circumferential surface 112cC1. Therefore, in a case in which the shaft 12C1 is pressed into the impeller cylinder portion 112C1, it is possible to distribute the pressing stress which is generated in the impeller cylinder portion 112C1 and it is possible to suppress the generation of cracks in the impeller using the pressing of the shaft 12C1.

In the other example illustrated in FIG. 10, the impeller cylinder portion 112C1 includes, on the inner circumferential surface 112cC1, a plurality of protruding portions 1123 which protrude to the inside in the radial direction. The inner circumferential surface 112cC1 of the impeller cylinder portion 112C1 is circular in plan view from the axial direction and includes the protruding portions 1123 on a portion of the inner circumferential surface 112cC1. The plurality of protruding portions 1123 are disposed at an equal interval in the circumferential direction.

In detail, the number of the protruding portions 1123 is three. However, the number of the protruding portions 1123 may be two or greater than or equal to four. In this example, the surface of the protruding portion 1123 facing the shaft 12C1 in the radial direction is a convex surface which protrudes toward the inside in the radial direction. The first portions 1121C include a portion of the surface of the protruding portions 1123 facing the shaft 12C1 in the radial direction. The number of protruding portions 1123 is three and the number of the first portions 1121C is three. The shaft 12C1 is press-fitted by three of the first portions 1121C. The number of the second portions 1122C which are interposed between two of the adjacent first portions 1121C in the circumferential direction is three.

In the configuration of the present embodiment described above, in a case in which the shaft 12 is pressed into the impeller cylinder portion 112, a configuration may be adopted in which the entire circumference of the outer circumferential surface of the shaft 12 is caused to contact and fix the inner circumferential surface of the impeller cylinder portion 112 unlike in the configuration of the third modification example described above.

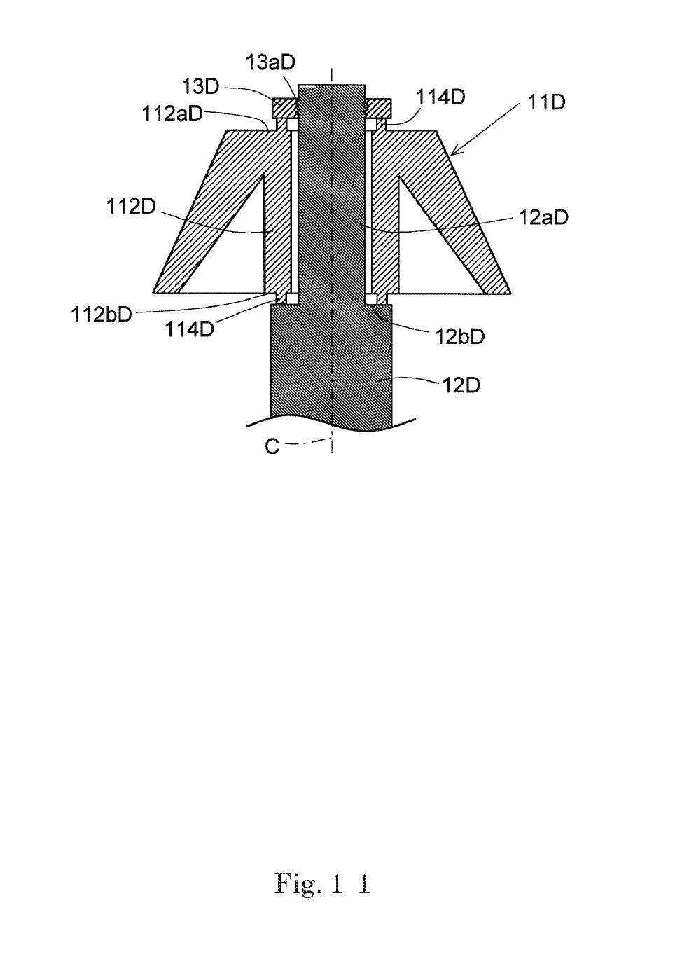

FIG. 11 is a view for explaining a fourth modification example of the vane wheel 1 according to the embodiment of the present disclosure. In detail, FIG. 11 is a view schematically illustrating a vertical cross section of a portion of the vane wheel. In the fourth modification example, a fixing member 13D is a nut which is provided with a screw thread 13aD which serves as a female screw on the inner circumferential surface. In this configuration, at least a portion of a top end portion 12aD (the one end portion in the axial direction) of a shaft 12D is provided with the screw thread which serves as the male screw. A portion of the top end portion 12aD of the shaft 12D protrudes to the top side from a convex portion 114D which is provided on a top end surface 112aD of an impeller cylinder portion 112D. The protruding portion is provided with a male screw.

By fastening the fixing member 13D which has the female screw to the male screw which is provided on the shaft 12D, the impeller 11D is interposed between the bottom surface of the fixing member 13D and a step surface 12bD and is fixed to the shaft 12D. The convex portions 114D are provided on the top end surface 112aD and a bottom end surface 112bD of the impeller cylinder portion 112D. Therefore, it is possible to absorb the force which is applied to the impeller cylinder portion 112D in the axial direction by the fastening of the fixing member 13D using the convex portions 114D and it is possible to suppress the generation of cracks in the impeller 11D accompanying the fastening of the fixing member 13D.

Even in this modification example, the fixing member 13D includes the screw thread 13aD in a direction in which the fixing member 13D is fastened by the rotation of the impeller 11D. In other words, the fastening direction of the fixing member 13D is the opposite direction from the rotation direction R of the impeller 11D. Accordingly, it is possible to prevent the fixing member 13D from being loosened by the rotation of the impeller 11D and it is possible to prevent the impeller 11D from coming out from the shaft 12D.

Features of the above-described preferred embodiments and the modifications thereof may be combined appropriately as long as no conflict arises.

It is possible to use the present disclosure on a blowing device having a vane wheel and a vacuum cleaner or the like which includes the blowing device, for example.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A vane wheel comprising:
a shaft which is disposed along a center axis;
an impeller which includes an impeller cylinder portion into which one end portion of the shaft in an axial direction is inserted; and
a fixing member which is disposed on one end side of the impeller cylinder portion in the axial direction and which fixes the shaft and the impeller to each other,
wherein the shaft includes a step surface which is a flat surface spreading outward in a radial direction at the other end of the one end portion of the shaft in the axial direction,
wherein the other end surface of the impeller cylinder portion in the axial direction faces the step surface in the axial direction,
wherein the impeller includes a convex portion which protrudes in the axial direction on at least one of one end surface and the other end surface of the impeller cylinder portion in the axial direction, and
wherein the convex portion is in contact with the fixing member or the step surface.

2. The vane wheel according to claim 1,
wherein an outer end portion of the convex portion in the radial direction is positioned inside an outer end portion of the fixing member or the step surface in the radial direction.

3. The vane wheel according to claim 1,
wherein the convex portion has a ring shape which continues in a circumferential direction.

4. The vane wheel according to claim 1,
wherein the convex portion includes a plurality of arc-shaped portions which are arranged with an interval in a circumferential direction.

5. The vane wheel according to claim 1,
wherein the impeller includes
a truncated cone-shaped impeller base portion including a plurality of vanes on an outer circumferential surface, and
a gap portion which is positioned between the impeller base portion and the impeller cylinder portion in the radial direction,
wherein the impeller cylinder portion is positioned inside the impeller base portion in the radial direction,
wherein the one end portion of the shaft in the axial direction is press-fitted into the impeller cylinder portion, and
wherein at least a portion of the one end portion of the shaft in the axial direction faces the impeller base portion with the gap portion in between in the radial direction.

6. The vane wheel according to claim 1,
wherein the impeller cylinder portion includes, on an inner circumferential surface thereof,
a plurality of first portions which are disposed with an interval in the circumferential direction, and are in contact with the shaft and fix the shaft, and
a plurality of second portions which face the shaft with an interval in the radial direction and each of which is positioned between two of the first portions which are adjacent in the circumferential direction.

7. The vane wheel according to claim 1,
wherein the shaft is fixed to the impeller cylinder portion using an adhesive.

8. The vane wheel according to claim 1,
wherein the fixing member includes a screw thread in a direction in which the fixing member is fastened by rotation of the impeller.

9. A blowing device comprising
the vane wheel of claim 1.
